(19) United States
(12) Patent Application Publication
(10) Pub. No.: US 2017/0247113 A1
(43) Pub. Date: Aug. 31, 2017

(54) Drone Provided with a Battery Pack Having a Stiffening Function

(71) Applicant: PARROT DRONES, Paris (FR)

(72) Inventors: Thierry SANLAVILLE, PARIS (FR); Maxime DUCLOUX, MEREVILLE (FR); Flavien MORRA, Pantin (FR)

(73) Assignee: PARROT DRONES, Paris (FR)

(21) Appl. No.: 15/441,112

(22) Filed: Feb. 23, 2017

(30) Foreign Application Priority Data
Feb. 25, 2016 (FR) 16 51571

(51) Int. Cl. B64D 27/00; B64C 27/08; B64D 47/08; B64C 39/02

(52) U.S. Cl. CPC B64D 27/00; B64C 39/024; B64C 27/08; B64D 47/08; B64C 2201/024; B64C 2201/042; B64C 2201/108; B64C 2201/165

(57) ABSTRACT

Embodiments disclosed include a rotary-wing drone that includes a drone body and linking arms, such that a propulsion unit is located at the distal ends of the linking arms. The rotary-wing drone may also include a stiff battery pack with at least one fixation means and a guiding profile. The drone body may also include a platform with at least one guiding rail configured to cooperate and receive the complementary guiding profile of the battery pack and at least one fixation means complementary to the fixation means of the battery pack so that the battery pack attaches onto and stiffens the drone body.

### CROSS RELATED APPLICATIONS

This application claims priority to French patent application No. 16-51571 filed on Feb. 25, 2016.

### TECHNICAL FIELD

The disclosed technology relates generally to motorized flying devices, such as drones. More specifically, the disclosed technology relates to drones with rotary wings of the quadricopter type.

### BACKGROUND

Examples of drones with rotary wings of the quadricopter type may be the AR Drone, the Bebop drone, or the Bebop 2 drone of Parrot SA, Paris, France. These exemplary drones are a quadricopter (four propulsion units) equipped with a series of sensors, such as accelerometers, three-axes gyrometers, altimeters and the like. Additionally, the drone may also include a front video-camera capturing images of the scenic environments to which the drone is directed.

Such drones may be equipped with four propulsion units that are each provided with a propeller. The propulsion units may be positioned at the distal end of the link arms, thus connecting the propulsion units to the drone body. Furthermore, these drones may include a plurality of drone supports or feet for supporting the drone, and in particular, when the drone is on the ground.

The structure and weight of the drone are two significant aspects that impact the flying performance of the drone. In particular, in terms of autonomy, such aspects may include responsiveness and agility to piloting.

The main weight source component of the drone is the battery pack of the drone. The drone will provide a housing structure for the insertion of the battery pack within the drone structure. The insertion of the battery pack is often a delicate task because the housing is often narrow and the user must usually carry out the electric connection of the battery pack connector to the electric connector of the drone before inserting the battery pack.

All of these operations are tedious and not very practical to the user. Furthermore, the battery pack inserted into the housing may move and hence influence the flight of the drone. As a result, the optimization of the battery pack with regards to its shape and integration into the drone plays a significant role.

### BRIEF SUMMARY OF EMBODIMENTS

According to various embodiments, disclosed are drones with a drone case in which part of the drone body that supports the battery pack (hereinafter “platform”) is relatively deformable, either due to its configuration of the arms that is particularly favorable to the formation of torsional/bending stresses of the platform or due to the absence of any internal stiffening element near the platform area.

In such a case, the deformations of the platform may affect the relative geometry of the four arms, which may be enough to disturb the aerodynamic behavior of the drone in flight. As a result, these deformation of the platform may rapidly generate noticeable difficulties with the piloting and the pitch stabilization during the flight of the drone. In particular, this may result in abrupt changes in altitude, which may generate significant differential stresses to the drone.

As a result, embodiments provided herein include a drone that make it possible to eliminate these drawbacks related to these aerodynamic behaviors that make it difficult to pilot and achieve pitch stabilization, or at the very least to reduce them to levels that are not measurable to disturb the drone's flight control.

Various embodiments include a rotary wing drone that includes:
a drone body with a frame structure with a front structure and a platform extending rearward from the front structure;
front linking arms fixed to the front structure, and rear linking arms fixed to the platform, where each of the front and rear linking arms include a propulsion unit at the distal ends of the linking arms; and
a battery pack adapted to be mounted on the platform of the frame structure, and including a fixation means for fastening the battery to the platform.

Additionally, further embodiments may also include:
a stiff battery pack that includes a fixation mechanism as well as a guiding profile;
a platform that includes at least one guiding rail arranged on a surface of the platform configured to receive the battery pack, where the platform is adapted to cooperate with the guiding profile of the battery pack with the guiding rail being a trapezoidal section and present on at least one part of the platform, and the guiding profile being a complementary shape to the guiding rail so that the guiding rail allows for a mechanical recovery for the torsional efforts of the frame structure when the drone flies; and
a platform that further includes at least one complementary fixation mechanism or means adapted to cooperate with the fixation mechanism or means of the battery pack. The fixation mechanism or means and complementary fixation mechanism or means may be configured to allow for the locking of the battery pack onto the platform.

With such an arrangement, the stiffness of the battery pack that is fastened to the frame structure of the drone may structurally reinforce the drone body and stiffen the body of the drone by avoiding a deformation of the platform and further incidental deformation of the rear linking arms when the drone flies.

According to various embodiments:
the points of fixation of the two front linking arms to the drone body and the points of fixation of the two rear linking arms to the drone body are located at different respective heights with respect to the horizontal median plane of the drone body, where the battery pack creates a structural relay between the points of fixation of the front linking arms by being positioned relatively high with respect to the points of fixation of the rear linking arms, which are positioned relatively low;
the fixation mechanism or means of the battery pack includes at least one hook, and the complementary fixation mechanism of the platform includes at least one element of relief on the platform, which may be configured to cooperate with at least one hook;
the front structure of the drone body may include a protruding element, where the battery pack includes a recess having a shape that is complementary to that of the protruding element of the front structure, and the recess includes a fixation mechanism configured to cooperate with a complementary fixation mechanism or means positioned on the protruding element on the drone body;
the battery pack includes a first part with a length and a width substantially identical to the length and width of the platform of the drone body; and a second part extending beyond the platform of the drone body, where this second part is thicker than the first part and extending at least in part opposite from the free end of the drone body, which includes a connection mechanism configured to cooperate with a complementary connection mechanism located on the free end of the platform;
a battery pack with a push-button that makes it possible to release the fixed battery pack, and thus allowing for the separation of the battery pack from the drone body;
a guiding rail that is substantially positioned on the central part of the platform; and/or
a guiding rail that is made over at least one part of the platform length, where the platform length may be defined as the length of the main direction of flight of the drone.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates a perspective view of a drone according to one particular embodiment.

FIG. 2 illustrates drone without a battery pack according to one particular embodiment.

FIG. 3 illustrates a platform of a drone body adapted to receive the battery pack according to one particular embodiment.

FIG. 4 illustrates a battery pack according to one particular embodiment.

FIG. 5 shows a vertical section of the drone in the transverse direction of the drone with an attached battery pack at the platform of the drone body according to the invention.

FIG. 6 illustrates a longitudinal vertical section of a drone with a battery pack according to one particular embodiment.

FIG. 7 illustrates a top view of a battery pack according to one particular embodiment.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

The following description is not to be taken in a limiting sense, but is made merely for the purpose of describing the general principles of the disclosed embodiments. The present embodiments address the problems described in the background while also addressing other additional problems as will be seen from the following detailed description. Numerous specific details are set forth to provide a full understanding of various aspects of the subject disclosure. It will be apparent, however, to one ordinarily skilled in the art that various aspects of the subject disclosure may be practiced without some of these specific details. In other instances, well-known structures and techniques have not been shown in detail to avoid unnecessarily obscuring the subject disclosure.

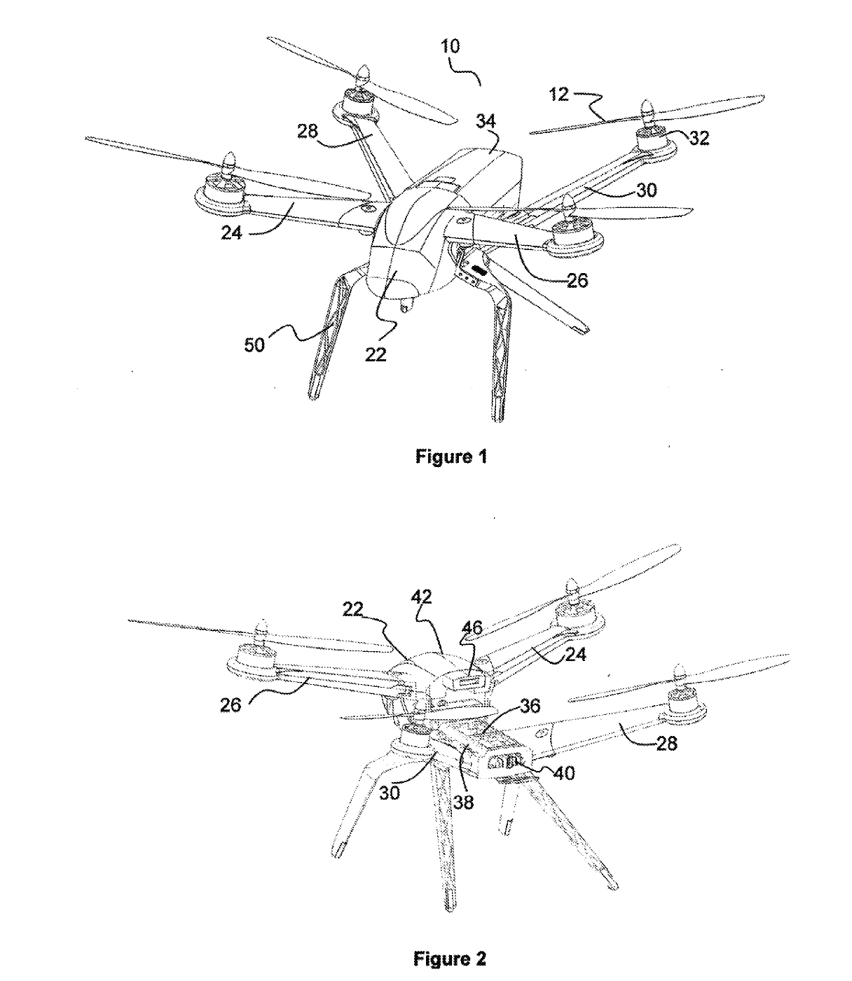

FIG. 1 illustrates a perspective view of a drone 10 according to one particular embodiment. As illustrated, the drone 10 is the quadricopter type. The quadricopter drone 10 may include a drone body 22 with two front linking arms 24, 26 and two rear linking arms 28, 30 extending from the drone body 22 with a propulsion unit 32 located on the distal ends of the linking arms 24, 26, 28, 30. The front and rear positions of the drone 10 may be defined with respect to the main flight direction of the drone 10. The propulsion unit 32 may include a motor with a propeller 12 assembled to the motor.

The propulsion units 32 may be piloted independently from each other by using an integrated navigation and attitude control system.

The drone 10 may also include a front-view camera (not shown) making it possible to obtain an image of the scene towards which the drone is directed. The drone 10 may also include a vertical-view camera (not shown) pointing downward, adapted to capture successive images of the overflown terrain and used in particular to evaluate the speed of the drone with respect to the ground.

The drone 10 may have a particular frame structure. By way of example, such a particular frame structure may include a “VTail” shape at the rear end of the drone with respect to the main displacement of flight of the drone 10. In other words, the frame may be modified in such a manner so that the two rear linking arms 28, 30 form a “V” shape. Hence, the points of fixation of the two front linking arms 24, 26 to the drone body 22 and the points of fixation of the two rear linking arms 28, 30 to the drone body 22 may be located at different respective heights with respect to the horizontal median plane of the drone body 22.

Furthermore, the two front linking arms 24, 26 of the drone 10 may form a first angle of inclination with respect to the horizontal median plane of the drone body 22 and the two rear linking arms 28, 30 may form a second angle of inclination with respect to the horizontal median plane of the drone body 22, in which the second angle is different from the first angle.

In accordance to an exemplary embodiment, the two front linking arms 24, 26 of the drone 10 may form an angle of about 0° to 10° with respect to the horizontal median plane of the drone body 22, and the two rear linking arms 28, 30 may form an angle between 15° to 45°. According to one particular embodiment, the angle relative to the two rear linking arms 28, 30 is about 30°.

The propellers 12 may be assembled to the propulsion units 32 of the front arm 26 and the rear arm 30, where they are positioned on the same plane, in particular, the same plane of rotation. Additionally, the propellers 12 may also be assembled to the propulsion units 32 of the other front arm 24 and the other rear arm 28, which are positioned on the same plane, in particular, the same plane of rotation. In other words, the propellers 12 assembled to the propulsion units 32 on the same side of the quadricopter drone 10 are positioned along the same plane, in particular, the same plane of rotation. The side of the drone 10 may be defined with regard to the main direction of flight of the drone 10.

In other embodiments, the propellers 12 may be assembled to the propulsion units 32 that are positioned along the same plane, in particular, the same plane of rotation.

The propellers 12 may be adapted to be disassembled from the propulsion unit 32, either to be stored or to be changed in instances where the propellers are damaged.

According to one particular embodiment, the propellers 12 may be assembled to the propulsion units 32 of the front linking arms 24, 26 such that the propellers 12 are 279 millimetres in diameter. Additionally, the propellers 12 assembled to the propulsion units 32 of the rear linking arms 28, 30 may be assembled so that the propellers 12 are 220 millimetres in diameter. However, it should be noted that these are only exemplary dimensions and that any other dimensions may be used.

The drone 10 may also include a battery pack 34 that may be assembled to the drone body 22. Furthermore, the drone 10 may also include drone supports 50 that allow the drone 10 to have a stable position when placed onto the ground.

In some embodiments, the drone 10 may include inertial sensors (i.e., accelerometers and gyrometers) that make it possible to measure with certain accuracy the angular speeds and altitude angles of the drone 10 (i.e., Euler angles—pitch, roll, and yaw) to describe the angular inclination of the drone 10 with respect to a horizontal plane of a fixed terrestrial reference system. It is well understood that the two longitudinal and transverse components of the horizontal speed are closely linked to the inclination according to the two respective pitch and roll axes.

Moreover, the ultrasonic range finder may be arranged under the drone 10 to provide an accurate measurement of the altitude with respect to the ground.

FIG. 2 illustrates drone without a battery pack according to one particular embodiment. The drone body 22 may include a platform 36 which is assembled to receive the battery pack.

The platform 36 of the drone body 22 may include a platform 36 that is configured to receive the battery pack with the use of at least one guiding rail 38. The guiding rail 38 may be configured to cooperate with a complementary guiding profile that is present on the battery pack.

The rear linking arms 28, 30 of the drone may be fixed on either side of the platform 38. According to a particular embodiment, the platform 36 may include an electric connection means 40 positioned on the free end of the platform 38. At the opposite end of the platform, the drone body 22 may include a front structure 42 of the drone. The front linking arms 24, 26 of the drone may be fixed to the front structure 42 of the drone.

The front structure 42 of the drone may include a device for controlling the drone, which may be a means for drone communications with a piloting device at least one front camera (not shown here).

Additionally, by way of example, the platform 36 of the drone body 22 may be relatively of low thickness, which thus may result in some deformation of the platform while the drone is flying. The “deformable” character of the platform 36 may be understood in that, during the flight, and in the absence of any additional stiffening means: i) the platform may undergo stresses resulting from the efforts produced by the propulsion units 32 and transmitted by the linking arms 24, 26, 28, 30, ii) these stresses would then generate torsional and/or bending deformations of the platform, affecting the relative geometry of the linking arms 24, 26, 28, 30, in particular the rear linking arms 28, 30 with respect to the front linking arms 24, 26, and consequently iii) produce sufficient disturbance to measurably impact the aerodynamic behaviour of the drone in flight.

As such, the noted stresses undergone by the platform 36 may be accentuated by the leverage present from the height differences of the linking arms 24, 26, 28, 30. Indeed, as illustrated, there may be a height difference between the front linking arms 24, 26 and the rear linking arms 28, 30. It will also be noted that the bending and torsional deformations of the platform 36 may be accentuated by the elongated shape of the platform 36.

To solve this problem, according to some embodiments, the battery pack to be attached and inserted onto the platform 36 may be hard and stiff. The battery pack may include at least one guiding profile and one fixation means to make it possible to assemble and fasten the battery pack to the drone body 22.

The “stiff” character of the battery pack may be understood as relative stiffness, which may undergone to the same efforts as the platform 36. This means that the proper bending/torsional deformation of the battery pack is lesser than that of the platform, or even almost null. As a result, when the battery pack and the platform 36 are fastened together to form a single-piece unit, the stiffness of the battery pack structurally reinforces and stiffens the drone body 22, hence avoiding a deformation of the platform 36 of the drone body 22. The drawbacks exposed hereinabove linked to the aerodynamic behaviour (difficulties of piloting, pitch stabilisation, etc.) as a result of deformation are then avoided, or at the very least reduced to levels that are not measurable so that drone flight is not disturbed.

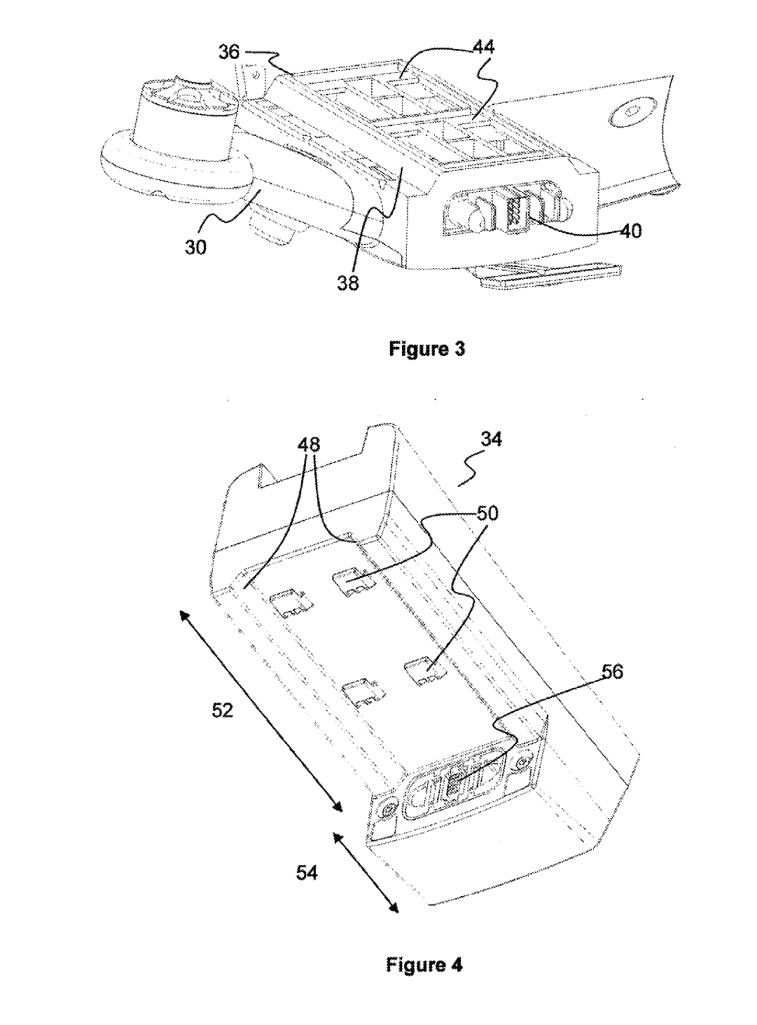

The drone body 22 may also include at least one fixation mechanism or means that is complementary to the fixation mechanism or means of the battery pack. FIG. 3 illustrates a platform 36 of a drone body adapted to receive the battery pack according to one particular embodiment. As illustrated, the guiding rail 38 of the platform 36 of the drone body is a trapezoidal section. The guiding rail 38 may be present on at least one part of the platform 36. The guiding rail may also be present along the length or along the width of the platform 36.

According to a particular embodiment, the guiding rail 38 is substantially positioned in the central part of the platform 36. However, as an alternative, the guiding rail may also be positioned substantially towards one side of the platform 36.

The guiding rail 38 of the platform 36 of the drone body allows for the positioning, and in particular, the automatic centering of the battery pack 34 at the time of installation of the battery pack. The guiding rail 38 also allows a mechanical recovery of the torsional efforts of the main structure generated in particular when the propulsion units operate during drone flight.

According to a particular embodiment, the platform 36 of the drone body further include one or several fixation mechanisms or means 44. The one or several fixation mechanisms or means 44 may be one or several elements adapted to cooperate and receive the corresponding fixation mechanisms or means of the battery pack.

As an alternative embodiment, an independent or additional fixation mechanism or means 46 may also be located at the front structure of the drone body, as illustrated in FIG. 2. More specifically, the fixation mechanism or means 46 may be present on a protruding element 46 of the drone body, which may be located on the upper part of the front structure of the drone body 22. Again, the additional fixation mechanism or means 46 may be configured to receive the complementary fixation mechanism or means of the battery pack so as to reinforce the fastening of the battery pack onto to the drone body.

FIG. 4 illustrates a battery pack 34 according to one particular embodiment. The battery pack 34 may include a guiding profile 48 that is complementary in shape to the guiding rail of the platform of the drone body.

The battery pack 34 may also include four complementary fixation mechanism or means 50. In particular four hooks may adapted to cooperate and receive the corresponding relief elements along the platform of the drone body. This mechanical fixation configuration thus allows for good mechanical strength and fastening of the battery pack 34 to the structure of the drone body.

Additionally, the battery pack 34 may include a first part 52 with a length and a width substantially identical to the length and width of the platform of the drone body. Furthermore, a second part 54 may be thicker than the first part 52 and extends at least in part opposite of the first end of the drone body. The second part 54 may include a connection mechanism or means 56 positioned to attach onto the free end of the platform.

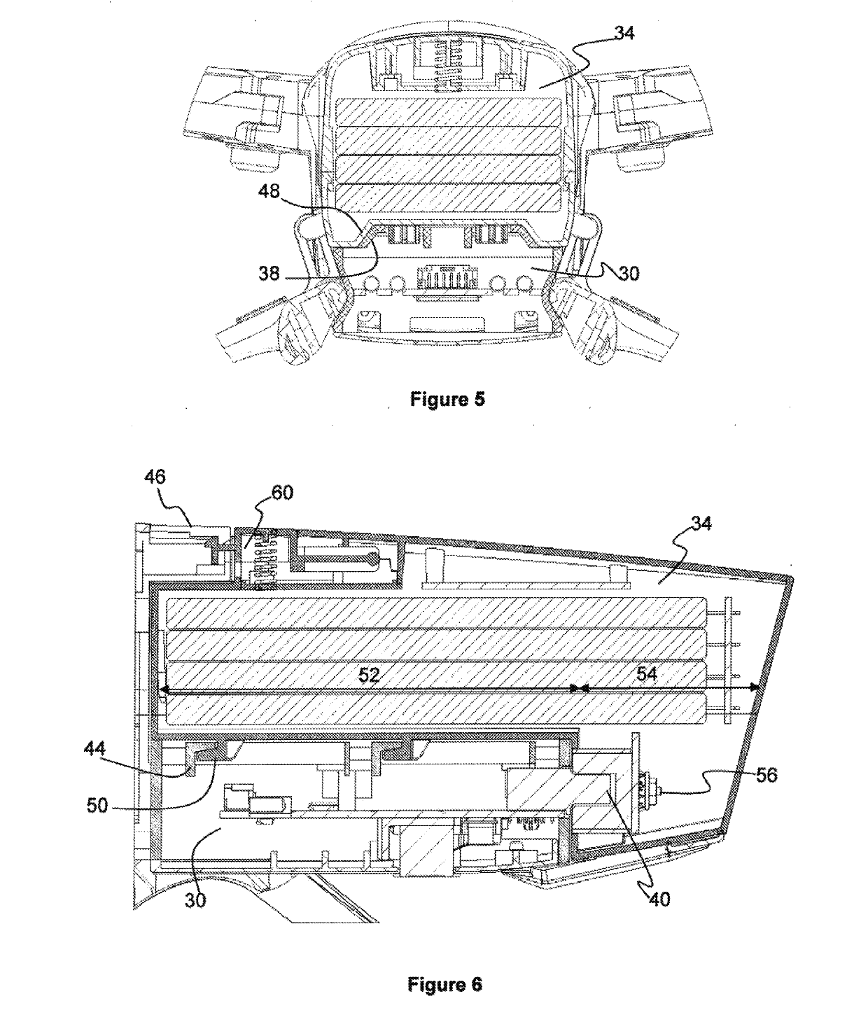

FIG. 5 shows a vertical section of the drone in the transverse direction of the drone with an attached battery pack 34 at the platform of the drone body according to the invention. More specifically, the Figures illustrates that a guiding profile 48 is present on at least one part of the battery pack 34 so as to properly attach onto the platform 30 of the drone body with the aid of the guiding rail 38 on the platform 30. The guiding profile 48 may be present along the length or along the width of the battery pack 34.

FIG. 6 illustrates a longitudinal vertical section of a drone with a battery pack 34 according to one particular embodiment. According to a particular embodiment, the battery pack 34 may include one or several fixation mechanisms or means, for example at least one hook 50 and the complementary fixation mechanism or means 44 located on the platform of the drone body. By way of example, complementary fixation mechanism or means 44 may be a complementary relief that is configured to adapt and receive the corresponding hook 50 on the battery pack 34.

Additionally, the battery pack 34 may also include a fixation mechanism or means 60 cooperating with a complementary fixation mechanism or means 46 positioned on the protruding element of the drone body. This may further allow the battery pack 34 to be securely positioned on the drone even when the drone is in flight.

Additionally, the battery pack 34 may also have a connection mechanism or means 56 that is configured to receive the complementary connection mechanism or means 40 positioned at the free end of the platform. Again, this may further allow the battery pack 34 to be securely positioned on the drone even when the drone is in flight.

As further illustrated, the figure shows that the battery pack 34 includes a first part 52 with a length and width that is substantially identical to the length and width of the platform of the drone. Furthermore, the figure also shows that the battery pack 34 includes a second part 54 that extends at least in part opposite the free end of the drone body.

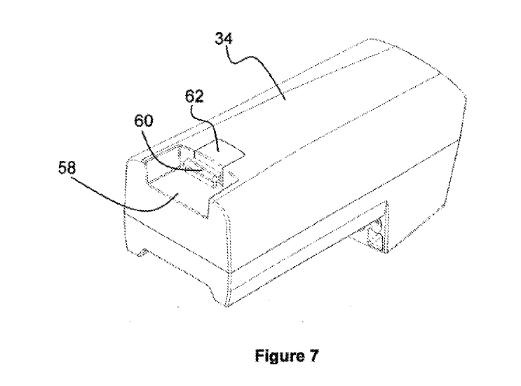

FIG. 7 illustrates a top view of a battery pack 34 according to one particular embodiment, According to an embodiment, the battery pack 34 may include a fixation mechanism or means adapted to cooperate with a complementary fixation mechanism or means present in particular of the front structure of the drone body. These fixation mechanisms or means allows for the locking of the battery pack 34.

As illustrated in FIG. 7, the battery pack 34 may include a recess 58 having a shape that is complementary to that of a protruding element on the drone. The recess 58 of the battery pack 34 may also include a fixation mechanism or means 60 cooperating with a complementary fixation mechanism or means positioned on the protruding element of the drone body.

According to a particular embodiment, the battery pack 34 may also include a push button 62 making it possible to release the fixation of the battery pack 34 from the platform, allowing for the translation of the latter for the separation from the drone body.

The assembly of the battery pack 34 to the drone body allows for a structural reinforcement of the drone with sufficient stiffness of the drone. The battery pack 34 may be positioned at the rear area of the drone so as to create a structural relay between the points of fixation of the front linking arms positioned at a relatively higher point than the points of fixation of the rear linking arms.

Additionally, the battery pack 34 may include an external envelop of the drone. Indeed, the battery pack 34 may form external structures attached to the drone.

Various embodiments have been described with reference to specific example features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various example embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the present application, whether or not such embodiments are described and whether or not such features are presented as being a part of a described embodiment. Thus, the breadth and scope of the present application should not be limited by any of the above-described example embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide illustrative instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed in multiple groupings or packages or across multiple locations.

Additionally, the various embodiments set forth herein are described in terms of example block diagrams, flow charts, and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A drone comprising:
a drone body with a frame structure comprising a front structure and a platform extending rearward from the front structure;
front linking arms fixed to the front structure and rear linking arms fixed to the platform where a propulsion unit is attached to a distal end of the front linking arms and the rear linking arms; and
a battery pack with a fixation mechanism for fastening the battery pack onto the platform;
wherein the platform comprises at least one guiding rail with a trapezoid shape on a surface of the platform to receive the battery pack by guiding the battery pack along at least one guiding rail and a first fixation mechanism adapted to couple with a corresponding second fixation mechanism located on the platform to lock the battery pack onto the platform.

2. The drone of claim 1, wherein the drone comprises a point of fixation of the front linking arms that is at a different height from a point of fixation of the rear linking arms with respect to a horizontal median plane of the drone body, such that the battery pack creates a structural relay between the points of fixation of the front linking arms and the points of fixation of the rear linking arms as the front linking arms are positioned at a higher point than the lower linking arms.

3. The drone of claim 1, wherein the second fixation mechanism comprises at least one hook and the first fixation mechanism comprises at least one relief on the platform that couples to at least one hook.

4. The drone of claim 1, wherein the drone further comprises:
a protruding element on the front structure of the drone; and
a recess on the battery pack as a fixation mechanism with a shape that is complementary to the protruding element on the front structure, such that the recess is configured to receive the protruding element.

5. The drone of claim 1, wherein the battery pack comprises:
a first part with a length and a width substantially identical to a length and a width of the platform of the drone body; and
a second part extending beyond the platform of the drone body, where the second part is thicker than the first part and also includes a connection mechanism that extends opposite from a front part of the drone body where the connection mechanism is configured to receive a complementary connection mechanism located on the platform opposite from the front part of the drone body.

6. The drone of claim 1, wherein the battery pack comprises a push button to release the battery pack attached onto the platform.

7. The drone of claim 1, wherein at least one guiding rail is positioned on a central part of the platform.

8. The drone of claim 1, wherein the guiding rail extends along a length of the platform.
